(19) United States
(12) Patent Application Publication
(10) Pub. No.: US 2007/0111189 A1
(43) Pub. Date: May 17, 2007

(54) Method and tool for surveying an individual or a plurality of individuals and collecting and displaying survey responses

(76) Inventor: Mark Nelson, Bannockburn, IL (US)

Correspondence Address: Joseph A. Fuchs;Everest Intellectual Property Law Group, P.O. Box 708, Northbrook, IL, 60065, US

(21) Appl. No.: 11/601,310

(22) Filed: Nov. 17, 2006

Related U.S. Application Data
(60) Provisional application No. 60/737,567, filed on Nov. 17, 2005.

(51) Int. Cl. G09B 3/00

(52) U.S. Cl. 434/350

(57) ABSTRACT

The present invention provides a method for providing a survey to an individual by displaying a video, audio, or audio/video presentation and collecting responses to the information display. The survey responses are collected over duration of the presentation and can be displayed along with the information display in a synchronized fashion.

### CROSS-REFERENCE TO RELATED APPLICATION

This application claims priority from U.S. Provisional Patent Application No. 60/737,567 filed on Nov. 17, 2005 which is incorporated herein by reference and made a part hereof.

### TECHNICAL FIELD

The present invention relates generally to a software enabled survey tool and method for providing a survey to an individual by displaying a video, audio, or audio/video presentation and collecting responses to the information display. The survey responses are collected over the duration of the presentation and can be displayed along with the information display in a synchronized fashion.

### SUMMARY OF THE INVENTION

A software enabled tool for surveying an individual including: (1) a device for providing the individual access to a presentation over a period of time; (2) a scale associated with the device having a maximum position, a minimum position and a neutral position disposed between the maximum position and the minimum position; (3) a pointer moveable by the individual over the scale to reflect a response to the presentation during the presentation; and (4) a recording device for documenting the position of the pointer at a plurality of times during the period of time. The invention further provides a device for summarizing and displaying results in a synchronized fashion.

### BRIEF DESCRIPTION OF THE DRAWINGS

FIG. 1 is a screen shot from a survey tool that displays a video presentation and allows for an individual to enter responses to the video presentation by moving a slider along a scale;

FIG. 2 is a screen shot of a data display tool for presenting survey results in coordination with the video display that is the subject of the survey; and

FIG. 3 is a flowchart of a process of the present invention.

### DETAILED DESCRIPTION

While this invention is susceptible of embodiment in many different forms, herein will be described in detail with the accompanying figures, a preferred embodiment of the invention. The present disclosure is to be considered as an exemplification of the principles of the invention and is not intended to limit the broad aspect of the invention to the embodiments illustrated and described.

The present invention provides a software enabled tool, and even more preferably a world wide web enabled tool, for collecting survey responses from an individual (surveyee) who observes a presentation. The present invention also provides a method or process for surveying an individual or a plurality of individuals. The software enabled tool can be stored in an electronic memory of a device such as a computer or an electronic processor containing device. In one form of the invention the computer has a preferred specification of at least 300 megabytes of internal memory (hard drive), one megabyte of RAM (random access memory), a DVD ROM player, a Pentium CPU, VGA monitor and a keyboard. In a preferred form of the invention, the presentation will include both audio and video components, however, it is contemplated the presentation can be video only, or audio only. It is also contemplated the software enabled tool can record responses to a presentation involving the stimulation of any of the senses of the surveyee including sight, sound, odor, taste, feel or any combination of these senses. Typically, the software enabled tool will be utilized by a subscriber or licensee of the tool. The user of the tool or the surveyor will be collectively referred to as a subscriber.

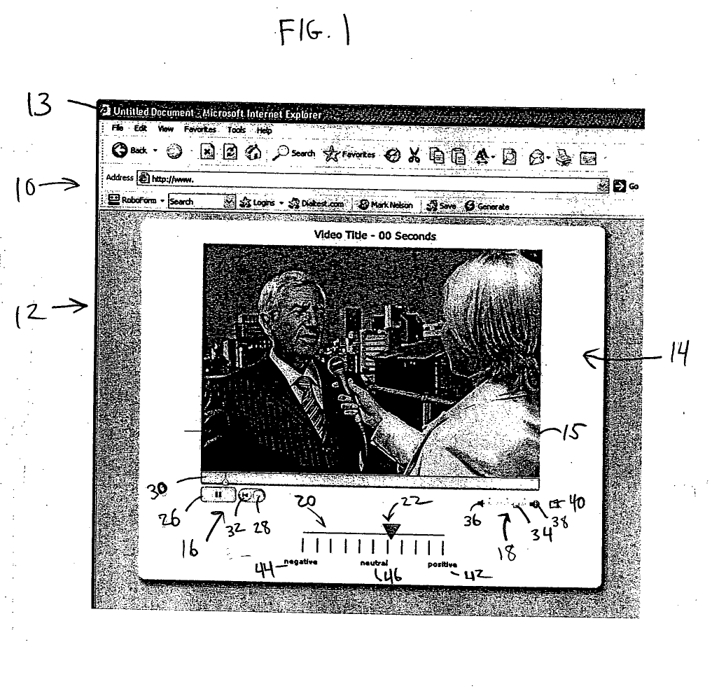

FIG. 1 shows a screen shot 10 of a world-wide-web-enabled survey tool 12 viewed within Microsoft Internet Explorer browser software 13. The survey tool 12 has a viewing window 14 for displaying a presentation 15; playback controls 16, volume controls 18, a graduated scale 20 providing a range of possible responses and a moveable selector 22 for selecting a discrete response among the range of possible responses. The playback controls 16 can include a start/pause button 26 that toggles between a start button and a pause button, a stop button 28, a control 30 for indicating current playback position relative to the duration of the presentation and a button 32 for returning the presentation to its beginning. Volume controls 18 include a volume slider 34 moveable by a mouse or keyboard control to move the slider to discrete positions between a low volume position 36 and a high volume position 38. The volume controls 18 can also include a mute button 40.

In one preferred form of the invention, the scale is labeled 20 with a maximum position or positive 42, a minimum position or negative 44 and intermediate positions there between including a middle or neutral position 46. The slider arm 22 can be manipulated by a surveyee using a computer mouse, keyboard keystrokes, touch pad, or other mouse like device or member associated with the computer as is well known in the art or by using other electronic devices such as manipulating a scroll wheel on an iPod, or other methods well known in the art. A surveyee will use the slider arm 22 to reflect whether he or she is favorably impressed by the presentation, unfavorably impressed, neutrally impressed or somewhere in between these settings. Thus, responses can be input at any time during the presentation and the responses are recorded in synchronized time with the presentation. The audio visual presentation can be presented in various forms such as in streaming video, or can be in any other suitable format that are well known to those skilled in the art. The audio visual presentation can be of a prerecorded event, an animated presentation or can be a live event.

It is also contemplated a survey could be imbedded in an electronic advertisement such as web page Flash advertisement where a drop down control panel encompassing the slider could be accessed in the advertisement for the purposes of rating that advertisement.

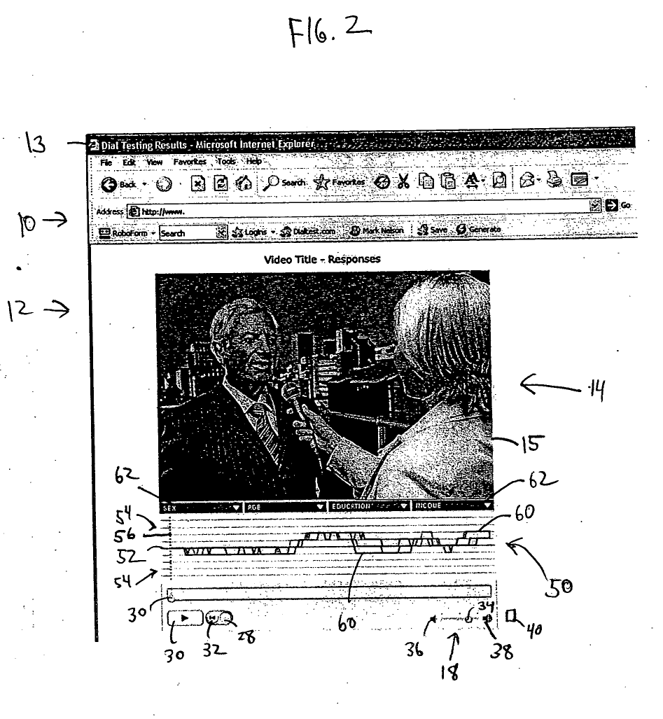

The software enabled tool also provides a tool for viewing the response or responses from surveyee(s) in coordination with the presentation. FIG. 2 shows a screen shot 10 of the survey-results viewing tool having the presentation display viewing window 15 as in FIG. 1, and a scale 50 showing a graphical presentation of the survey results. The graphical presentation can be in any form that conveys the results of the survey. The graphical presentation shown has a horizontally extending neutral line 52 with horizontally extending lines 54 spaced above and below the neutral line 52 that correspond in degree with the survey inputs of negative and positive. A vertical line 56 moves from left to right indicating the current position of the presentation and delineates the response at that point in time.

The survey results can be collected, grouped, averaged and displayed in accordance with the identity of the surveyee or by predefined groups such as the surveyee's gender, age, level of income, level of education, eye color, hair color, race, nationality or other information of interest to the subscriber. FIG. 2 shows numerous lines 60 on the graphical presentation 50 that can represent the responses collected from each predefined group. The display tool allows for changing how the information is displayed using drop down lists 62 or by other method known to those skilled in the art. Thus, the surveyor, for example, can view male responses along with female responses, or the responses of people with a high school education versus those that do not have a high school education, etc.

The survey results can also be downloaded by subscribers in any format convenient to the subscriber and in one form can be downloaded as in MS Excel file format as numerical data.

The present invention further provides a software enabled, and more preferably, a web enabled tool for subscribers to create surveys, disseminate surveys to a desired group of potential surveyees and collecting survey results. This tool is particularly useful for facilitating market research for advertising purposes. It is contemplated that market research companies will subscribe to use the software tool and will utilize the tool to construct surveys with the questions they wish to have answered; and to create the scale, including defining a minimum, average and maximum labels for inputting responses. The software tool further includes a database for collecting and storing identification and demographic information of potential surveyees. The tool will also allow for disseminating electronically a survey to the potential surveyees and to collect the responses electronically such as through email or input into a website. The subscriber can also specify the maximum number of survey results they will accept.

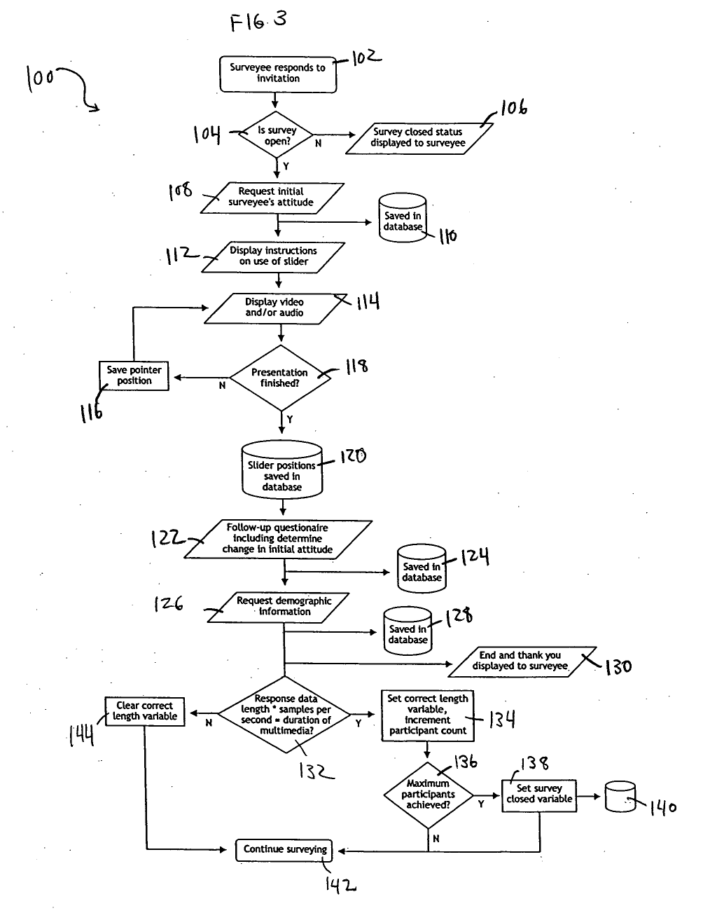

The subscriber can use the tool to send an invitation to a potential surveyee a URL by email to take a survey. The invitation can also be sent by regular mail via the U.S. Postal service or other courier service. The URL is tailored with an identification number of the survey and a unique user identification number to identify the surveyee. A process 100 for surveying an individual or a plurality of individuals is shown in FIG. 3. A surveyee can respond to the invitation 102 by clicking on the URL and the potential surveyee will be directed by Internet browsing software such a Microsoft Explorer, or the like, to an entry page that records the survey identification number and consults a survey database to determine if the survey is active 104. If a maximum number of participants have been reached, the user sees a “survey is closed” message 106. More invitations are sent out than the maximum number needed to account for people who do not immediately view the survey, or who do not complete the survey.

If the survey is not closed, the surveyee is presented the first page of a questionnaire 108 to determine attitudes of the surveyee prior to his or her viewing of the presentation. The survyee's attitude is stored in a database 110 and will be requested again after the presentation to determine whether the presentation has changed the surveyee's attitude or opinion. This survey can consist of a single question or a number of questions and the surveyees responses can be answered using the selector or by using keyboard keystrokes or mouse clicks. The surveyee then sees instructions 112 on using the moveable selector or slider 22. The surveyee then views 114, in this embodiment, a video or audio video presentation and moves the selector in accordance with the instructions to reflect his or her impression of the presentation, e.g. favorable, unfavorable, neutral or somewhere in between these positions. The selector's 22 position is preferably sampled 116 at a rate of once every 5 seconds, more preferably once every second and most preferably at least once every ½ second on a scale of 0 to 10 while the presentation is playing. It is contemplated that the sampling rate could be varied to any time interval without departing from the scope of the present invention. If the presentation stalls in playing, the sampling pauses also.

At end of presentation 118 the response data is saved in a response database 120 and a follow-up questionnaire is displayed 122 to the surveyee and his or her responses are saved in a database 124. After the follow-up a final page of demographic questions 126 is asked. When the surveyee completes the survey, the responses are stored in the database 128, and a message 130 is displayed that the survey is complete with a note thanking the surveyee for participating in the survey.

Upon completion of the survey a flag is set in the database to show that database row is valid, and a variable is stored indicating total length of response data samples. Response data length is compared to video duration 132 to insure a full set of data has been collected. If the data length has the correct duration, a variable indicating the total number of respondents is incremented 134 and a check is made to see if the maximum number of samples has been collected 136. If so, the survey is closed 138 to new surveyees, and an e-mail 140 is sent to the subscriber informing them of a change in survey status automatically. If the maximum number of surveys has not been reached the survey remains open and the process 100 is repeated 142 until the maximum number of surveyees has been recorded or another condition has been reached to terminate the survey process such as a certain date has been reached.

If the data length does not have the correct duration 144 the samples are excluded from the summary results but the data is saved for debugging transmission errors.

It is contemplated the tool can also provide for compensating the surveyees who have participated in the survey by sending the surveyees frequent flyer miles, coupons for the purchase of merchandise or other item.

While the specific embodiments have been described, numerous modifications come to mind without significantly departing from the spirit of the invention and the scope of protection is only limited by the scope of the accompanying claims. This design is just one example of a pattern design having these favorable characteristics, and disclosure of it is merely one example of a design having its favorable characteristics, others of which are not significant departures from the spirit of the invention.

I claim:

1. A software enabled tool for surveying an individual or group of individuals comprising:
a device for providing the individual access to a presentation over a period of time;
a scale associated with the device having a maximum position, a minimum position and a neutral position disposed between the maximum position and the minimum position;
a pointer moveable by the individual over the scale to reflect a response to the presentation during the presentation; and
a recording device for documenting the position of the pointer at a plurality of times during the period of time concurrent with the presentation to define a results set of responses.

2. The tool of claim 1 further comprising a display device for simultaneously displaying the presentation and a graphical representation of the results set of responses.

3. The tool of claim 1 wherein the tool has a communicator for sending a communication to a potential surveyee inviting the potential surveyee to participate in the survey.

4. The tool of claim 3 wherein the communication is an email communication.

5. The tool of claim 1 further comprising a counter to count the number of individuals who have viewed the presentation over the entire period of time to define a running total.

6. The tool of claim 5 further comprising a comparator that compares the running total to a preset maximum number surveyees and if the running total is less than the maximum number than the survey will remain available for other potential surveyees.

7. The tool of claim 6 wherein the communicator will be instructed to send a number of communications greater than the maximum number of surveyees.

8. The tool of claim 1 wherein the device is a computer.

9. The tool of claim 8 wherein the pointer can be moved using a member associated with the computer.

10. The tool of claim 9 wherein the member is selected from the group consisting of a keyboard, a mouse, a touch pad, and a scroll wheel.

11. A method for surveying an individual comprising:
inviting the individual to participate in a survey;
providing the individual access to observe a presentation over a period of time;
providing a scale with a maximum value, a minimum value and a neutral value therebetween;
providing a selector for manipulation by the individual for selecting positions on the scale during the presentation;
recording the position of the selector periodically over the period of time; and
repeating the recording step over the period of time to define a results set of responses.

12. The method of claim 11 wherein the presentation is of a type selected from the group consisting of an audio visual presentation, a visual presentation, a audio presentation, an odor presentation, a feel presentation.

13. The method of claim 11 wherein access to the presentation is provided by a web-browser software.

14. The method of claim 13 wherein the individual is invited to take the survey by an email communication providing the individual with a URL to be entered into the web browser software.

15. The method of claim 11 wherein the selector can be moved continuously during the period of time.

16. The method of claim 11 wherein the recording step is repeated at least once every five seconds.

17. The method of claim 11 wherein the recording step is repeated at least once every second.

18. The method of claim 11 wherein the recording step is repeated at least once every ½ second.

19. The method of claim 11 wherein the presentation is provided by streaming video.

20. The method of claim 14 wherein the URL includes a first number to identify the survey and a second identification number to identify the surveyee.
